(19) United States
(12) Patent Application Publication
(10) Pub. No.: US 2016/0171699 A1
(43) Pub. Date: Jun. 16, 2016

(54) AUTOMATED REGISTRATION OF THREE-DIMENSIONAL VECTORS TO THREE-DIMENSIONAL LINEAR FEATURES IN REMOTELY-SENSED DATA

(71) Applicant: DigitalGlobe, Inc., Longmont, CO (US)

(72) Inventors: Jacek Grodecki, Thornton, CO (US); Josh Nolting, Thornton, CO (US)

(21) Appl. No.: 14/730,216

(22) Filed: Jun. 3, 2015

Related U.S. Application Data
(63) Continuation-in-part of application No. 14/681,043, filed on Apr. 7, 2015.
Application No. 14/681,043 is a continuation-in-part of application No. 13/942,356, filed on Jul. 15, 2013.
Application No. 13/942,356 is a continuation of application No. 13/417,568, filed on Mar. 12, 2012, now Pat. No. 8,488,845.
Application No. 13/417,568 is a continuation of application No. 12/606,918, filed on Oct. 27, 2009, now Pat. No. 8,155,391.
Application No. 12/606,918 is a continuation-in-part of application No. 11/764,765, filed on Jun. 18, 2007, now Pat. No. 7,653,218.
Application No. 11/764,765 is a continuation-in-part of application No. 11/416,276, filed on May 2, 2006, now abandoned.
(60) Provisional application No. 62/007,094, filed on Jun. 3, 2014.
(60) Provisional application No. 61/976,483, filed on Apr. 7, 2014.

(51) Int. Cl. G06T 7/00; G06K 9/00

(52) U.S. Cl. CPC G06T 7/0028; G06K 9/00651

(57) ABSTRACT

A system for automated vector updating, comprising a database that stores raster and vector information, and a vector processing server that algorithmically processes vectors for updates, and methods for algorithm-based vector updating.

### CROSS-REFERENCE TO RELATED APPLICATIONS

This application is a continuation-in-part of U.S. patent application Ser. No. 14/681,043, titled “ADVANCED SEMI-AUTOMATED VECTOR EDITING IN TWO AND THREE DIMENSIONS”, filed on Apr. 7, 2015, and claims the benefit of, and priority to, U.S. provisional patent application Ser. No. 61/976,483, filed on Apr. 7, 2014 and titled “ADVANCED VECTOR EDITING”, and which is also continuation-in-part of U.S. patent application Ser. No. 13/942,356, titled “SEMI-AUTOMATIC EXTRACTION OF LINEAR FEATURES FROM IMAGE DATA INCLUDING PATH WIDTH ATTRIBUTION”, which was filed on Jul. 15, 2013 which is a continuation of U.S. patent application Ser. No. 13/417,568, titled “SEMI-AUTOMATIC EXTRACTION OF LINEAR FEATURES FROM IMAGE DATA”, now patented as U.S. Pat. No. 8,488,845, which was filed on Mar. 12, 2012 and is a continuation of U.S. patent application Ser. No. 12/606,918, titled “SEMI-AUTOMATIC EXTRACTION OF LINEAR FEATURES FROM IMAGE DATA”, now patented as U.S. Pat. No. 8,155,391, which was filed on Oct. 27, 2012 and is a continuation-in-part of U.S. patent application Ser. No. 11/764,765, titled “SEMI-AUTOMATIC EXTRACTION OF LINEAR FEATURES FROM IMAGE DATA”, now patented as U.S. Pat. No. 7,653,218, which was filed on Jun. 18, 2007 and is a continuation-in-part of U.S. patent application Ser. No. 11/416,276, titled “Semi-automatic extraction of linear features from radar image data”, now abandoned, which was filed on May 2, 2006, the entire specifications of each of which is incorporated herein in its entirety by reference. This application also claims priority to U.S. provisional patent application Ser. No. 62/007,094, titled “TECHNIQUES FOR VECTOR UPDATING”, filed on Jun. 3, 2014, the entire specification of each of which are incorporated herein by reference.

### BACKGROUND OF THE INVENTION

1. Field of the Art

The disclosure relates to the field of image processing, and more particularly to the field of automatic vector re-registration to linear features in remotely-sensed imagery.

2. Discussion of the State of the Art

The DigitalGlobe-developed ROADTRACKER® has the ability to automatically update (register) an existing collection of two-dimensional linear feature vectors so that they better coincide with intended linear feature centerlines in remotely-sensed imagery. The initial discrepancy between the existing vectors and the linear features in the imagery may be due to poor geo-location of the initial vectors or over-generalization during the initial extraction process. The update utilizes local image information, and goes beyond, for example, the concept of applying a single uniform affine transformation to all the vectors.

The above described functionality focuses on two dimensions. What is needed is a system and methods to perform a similar kind of automatic update on three-dimensional linear feature vectors, and to visualize the resulting vectors in a two- and three-dimensional context. Beyond the initial three-dimensional vectors themselves as input, the update and display might utilize one of two types of additional information: (1) a high-resolution monoscopic image raster and an associated Digital Surface Model (DSM), or (2) a high-resolution stereo image pair.

### SUMMARY OF THE INVENTION

Accordingly, the inventor has conceived and reduced to practice a system and various methods to perform automatic re-registration of existing three-dimensional linear feature vectors to linear features in remotely sensed imagery, and to visualize the resulting vectors in two- and three-dimensional context. The update utilizes local scene information, and goes beyond applying a single uniform affine transformation to all the vectors.

According to a preferred embodiment of the invention, a system for rerouting image vectors comprising a vector analysis server stored and operating on a network-connected computing device, a routing calculation server stored and operating on a network-connected computing device, and a rendering engine stored and operating on a network-connected computing device, is disclosed. According to the embodiment, a vector analysis server may be utilized to perform analysis operations on received vectors such as (for example) retrieving and analyzing vectors from a vector storage such as a database or other data storage means (such as, for example, integral or removable hardware-based storage such as a hard disk drive, or software-based storage schema common in the art). Additionally, an analysis server may analyze raster images such as by retrieving from a raster storage, for example such as map images or similar raster-based image data. These analyzed vectors and rasters may then be provided to a routing calculation server, that may then identify or associate a plurality of vector points or paths with a raster image, for example identifying a vector-based path and correlating it with a raster-based satellite image of a physical space, forming a combined “route” representing a vector path through the physical space.

Calculated routes may then be provided to a rendering engine, that may analyze the routes and form visualizations of the combined vector and raster data such as may be presentable on a viewer such as a display screen, for example for review by a human user. Additionally, a user may interact with the visualization presented using a variety of input devices such as (for example) a computer mouse or keyboard, such as to manipulate the visualization or modify the information being presented. User input may be received by the rendering engine and utilized to update the rendering appropriately (such as to zoom in or out, for example), or may be further provided by the rendering engine to a routing calculation server as needed, for example to recalculate a route based on user modification (such as according to any of the methods described below, referring to FIGS. 6-7 and FIG. 10). As needed, modified routes may be further provided to a vector analysis server, for example to analyze new vector points based on user input, or for storage for future reference.

According to another preferred embodiment of the invention, a plurality of software-based processing methods for execution on a system for rerouting image vectors, are disclosed.

According to a preferred embodiment of the invention, a system for automatic image-based vector updating comprising a database that may store vector or raster-based information, a vector processing server that may perform vector and raster processing operations such as automatically updating a vector based on an input (as described below, referring to FIG. 6), is disclosed. According to the embodiment, the vector processing server may receive input (such as raster-based image data or vector data) from the database to perform processing operations on the data, and may optionally be connected via a network (such as the Internet, or other suitable data communication network) to external systems such as for vector generation or storage, or user input systems such as computer display, keyboard, or mouse devices to facilitate user input when appropriate (for example, in a semi-automated arrangement for to review the results of automated operation as described herein).

According to another preferred embodiment of the invention, An algorithm to geometrically update an existing set of three-dimensional linear feature vectors so as to make them better coincide with the linear features in an instance of remotely sensed imagery, is disclosed. According to the embodiment, the method may be used to geometrically update an existing set of three-dimensional linear feature vectors, for example to make them better coincide with the linear features in an instance of remotely sensed imagery. In an initial step an input may be received at a vector processing server, which may then be processed in a next step to derive vector-based point or path data, or raster-based pixel or cost data (such as described below in greater detail) from the input. In a next step the derived data may then be used to concatenate vectors where appropriate (as described below, e.g. when two vectors converge). In a next step, the derived data may be used to algorithmically process the vectors for updates, such as to conform to a more efficient path based on derived cost data from a raster image, or to “clean up” a vector by removing duplicate or erroneous data. Detailed algorithm examples are described below, referring to FIG. 6.

In another embodiment of the invention, an extension of the two-dimensional update capability described above (referring to the method 600 described in FIG. 6) to the realm of three-dimensional vectors is disclosed. As envisioned by the inventors, ideally a digital surface model (DSM) should be readily available to represent a three-dimensional surface over a raster image representing a two-dimensional plane.

In another embodiment of the invention, an additional automated extension of the two-dimensional update capability to the realm of three-dimensional vector data is disclosed. In particular, how to perform an update of an existing set of three-dimensional linear feature vectors given an HRS stereo image pair.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for advanced vector editing, according to a preferred embodiment of the invention.

FIG. 6 is a method flow diagram illustrating an exemplary set of methods for two-dimensional image-based vector routing, according to a preferred embodiment of the invention.

FIG. 7 is a method flow diagram illustrating an exemplary set of methods for three-dimensional image-based vector routing, according to a preferred embodiment of the invention.

FIG. 8 is an illustration of an exemplary vector routing user interface, illustrating the use of manual routing correction in a projection of a vector onto a raster image.

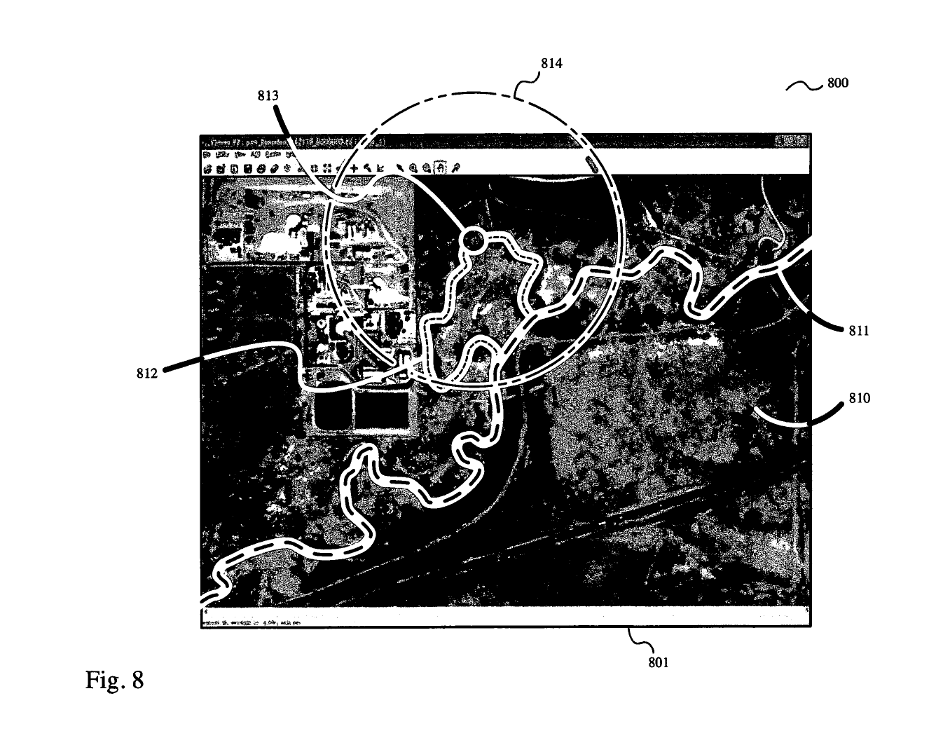

FIG. 9 is an illustration of an exemplary vector routing user interface, illustrating the use of vector routing in a three-dimensional vector projection.

FIG. 10 is a method flow diagram illustrating an exemplary method for algorithmic image-based vector updating, according to a preferred embodiment of the invention.

FIG. 11 is an illustration of an exemplary vector display, illustrating the use of algorithmic image-based vector updating according to the invention.

### DETAILED DESCRIPTION

The inventor has conceived, in a preferred embodiment of the invention, a system and methods for automatic three-dimensional vector updating.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

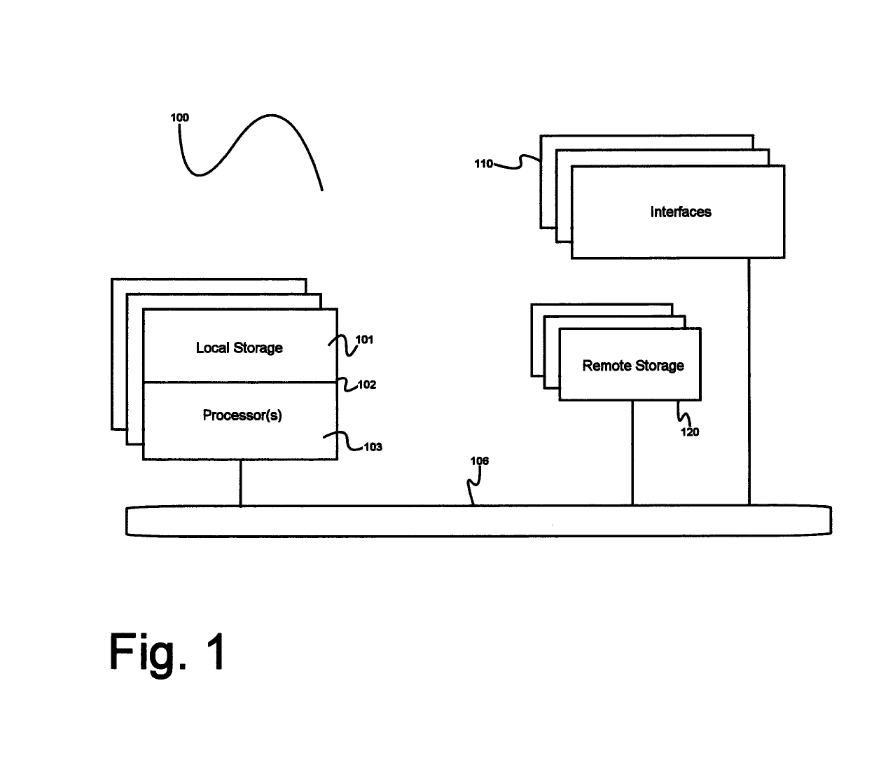

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

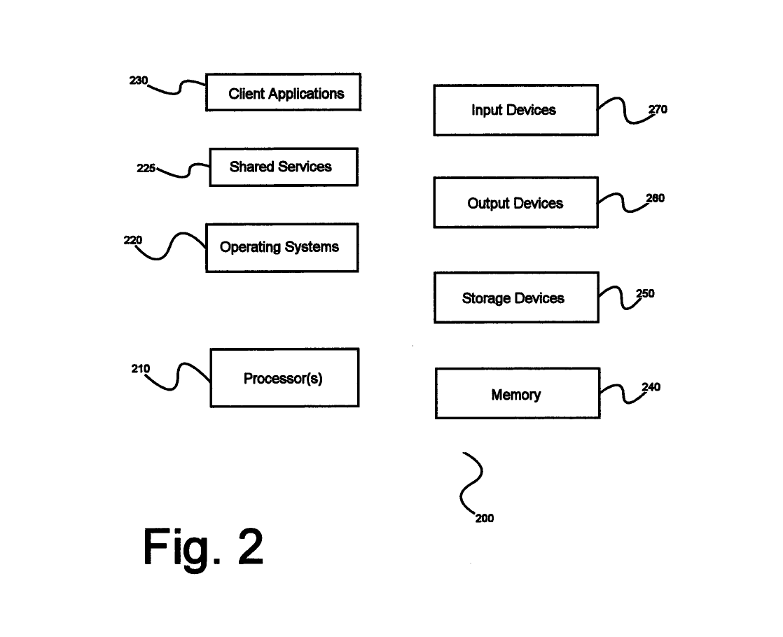

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

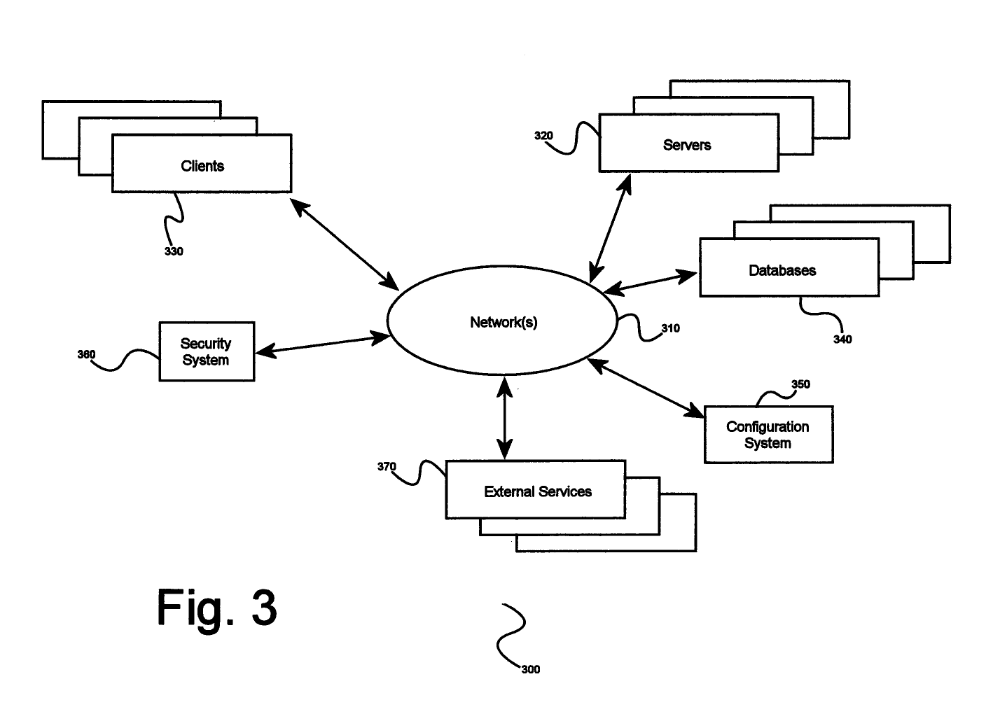

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

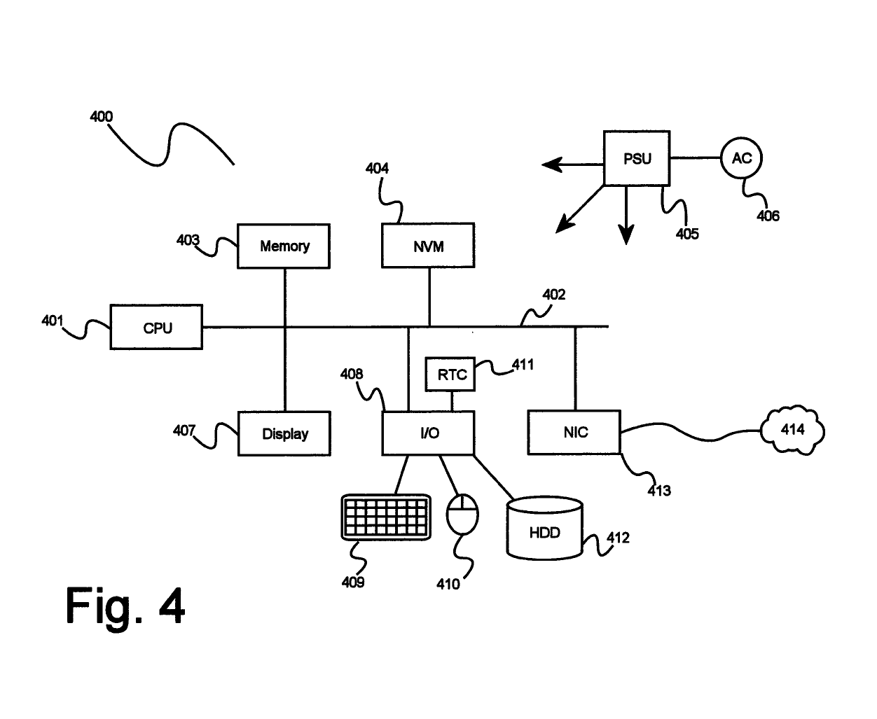

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Detailed Description of Exemplary Embodiments

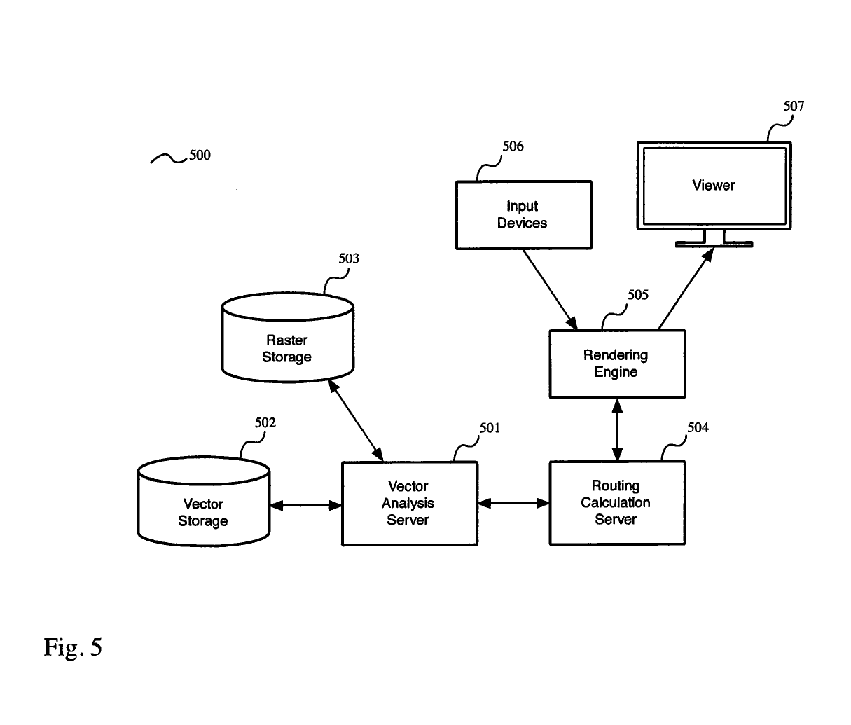

FIG. 5 is a block diagram of an exemplary system architecture 500 for advanced vector editing, according to a preferred embodiment of the invention. According to the embodiment, a vector analysis server 501 may be stored and operating on a network-connected computing device, and may be utilized to perform analysis operations on received vectors such as (for example) retrieving and analyzing vectors from a vector storage 502 such as a database or other data storage means (such as, for example, integral or removable hardware-based storage such as a hard disk drive, or software-based storage schema common in the art). Additionally, an analysis server 501 may analyze raster images such as by retrieving from a raster storage 503, for example such as map images or similar raster-based image data. These analyzed vectors and rasters may then be provided to a routing calculation server 504, that may then identify or associate a plurality of vector points or paths with a raster image, for example identifying a vector-based path and correlating it with a raster-based satellite image of a physical space, forming a combined “route” representing a vector path through the physical space.

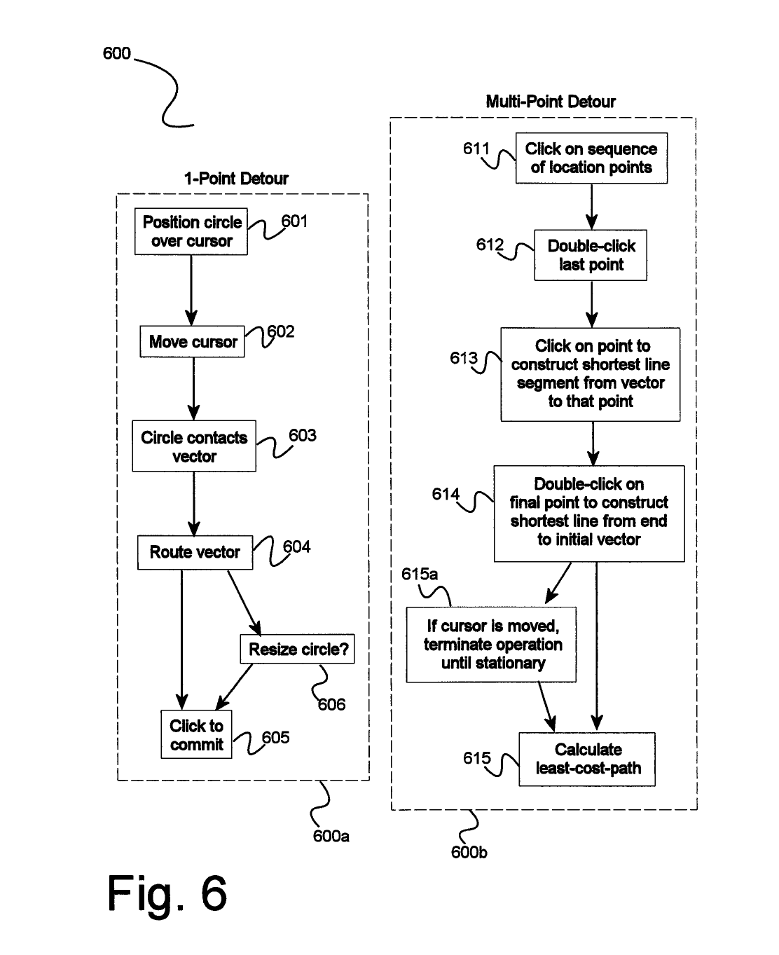

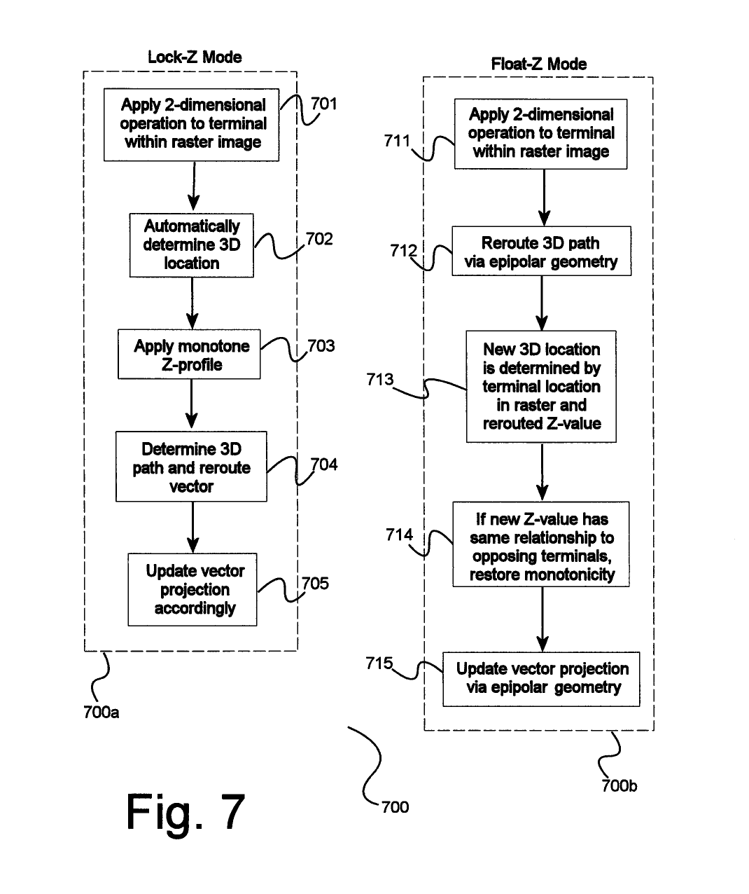

Calculated routes may then be provided to a rendering engine 505, that may analyze the routes and form visualizations of the combined vector and raster data such as may be presentable on a viewer 507 such as a display screen, for example for review by a human user. Additionally, a user may interact with the visualization presented using a variety of input devices 506 such as (for example) a computer mouse or keyboard, such as to manipulate the visualization or modify the information being presented. User input may be received by the rendering engine 505 and utilized to update the rendering appropriately (such as to zoom in or out, for example), or may be further provided by the rendering engine 505 to a routing calculation server 504 as needed, for example to recalculate a route based on user modification (such as according to any of the methods described below, referring to FIGS. 6-7). As needed, modified routes may be further provided to a vector analysis server 501, for example to analyze new vector points based on user input, or for storage for future reference.

It should be appreciated that according to the embodiment, various means of connection or communication between the components of a system 500 may be utilized according to the invention interchangeably or simultaneously, such as for example a direct, physical data connection (such as via a data cable or similar physical means), a software-based connection such as via an application programming interface (API) or other software communication means (such as may be suitable, for example, in arrangements where multiple system components may operate on a single hardware device such as a computing server or workstation), or any of a variety of network connections such as via the Internet or other data communications network. It should therefore be appreciated that the connections shown are exemplary in nature and represent only a selection of possible arrangements, and that alternate or additional connections may be utilized according to the invention.

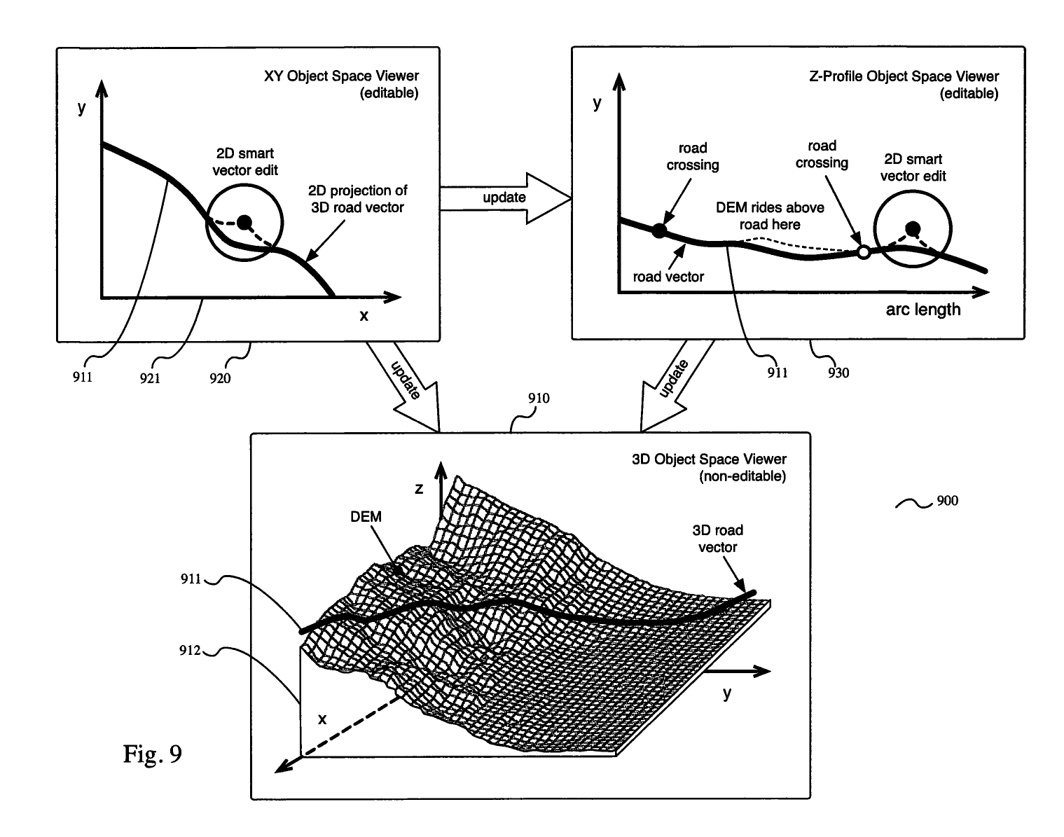

FIG. 9 is a diagram illustrating A user interface 900 for monoscopic visualization of three-dimensional linear feature vectors before and after they have been updated. According to the embodiment, a user interface 900 may comprise a plurality of graphical viewers such as:
A three-dimensional viewer 910 that can display the three-dimensional vectors 911 against a digital surface model (DSM) 912 or optionally against an empty three-dimensional space. The viewer may optionally offer perspective or non-perspective viewing, and enable the user to pan, zoom, or yaw about the line of sight. The DSM 912 may be opaque or semi-transparent or represented as a wireframe. A semi-transparent DSM 912 may allow a user to see where a three-dimensional vector 911 lies above or below the landscape represented by the DSM 912. (Alternatively the vector 911 could always be displayed on top of the opaque DSM 912, but have a portion of the vector rendered differently when trying to indicate that this portion of the vector corresponds to a trajectory below the DSM, for example using a dashed line or similar visual indicator.) The viewer may support pan, zoom, and yaw, such that a user may control or manipulate the view as described above. The three-dimensional vectors 911 in this viewer may optionally not be editable through this viewer—being represented in a read-only, or display-only, form.
A two-dimensional overhead XY-viewer 920 may display the three-dimensional vectors 911 projected to the XY-plane 921 of a raster image. The viewer may, as above, support pan, zoom, and yaw about the line of sight.
A two-dimensional Z-profile viewer 930 may display, for any designated three-dimensional vector 911, its profile of XY-arc-length vs. Z, optionally overlaid on corresponding “vertical slices” of the DSM 912. The viewer may, again, support pan and zoom. The viewer may show, as a dot, the coordinates where any other vector crosses or is incident to the current vector.

When the mouse cursor is moved along a vector in any of the viewers, then all other viewers depicting that vector will display the corresponding cursor location. Additionally, each viewer may optionally simultaneously display “before-and-after” vectors for a given change, for sake of real-time comparison.

When saying “automatically project the two-dimensional vectors vertically to the DSM”, this should be understood to mean automatically project the vectors to a slight vertical lift of the DSM and then automatically smooths the result in the vertical direction using standard techniques—the lift, for the most part, prevents the smoothed result from dropping locally below a DSM.

The interface may be allowed to support more than one Z-profile viewer, each viewer showing a different vector. This might be useful when looking at two vectors that cross each other in XY or are incident to each other in XY.

When image raster and associated DSM are available, the algorithm for automatic update of three-dimensional vectors is as follows: (1) automatically reject the existing three-dimensional vectors to the XY-plane of the image raster; (2) automatically perform two-dimensional vector update on the projected vectors using the image raster; (3) automatically project the updated two-dimensional vectors to the DSM.

According to a further embodiment of the invention, a user interface for stereoscopic visualization of three-dimensional linear feature vectors before and after they have been updated may comprise a plurality of graphical viewers such as:
A stereo three-dimensional viewer displaying the three-dimensional vectors against a (possibly semi-transparent) stereo view of the landscape. It will be possible to see where a vector lies above or below the landscape. The viewer supports pan, zoom, and yaw about line of sight.
Two monoscopic two-dimensional image space viewers, one for each raster image in the stereo pair. The three-dimensional vectors in object space are projected onto the raster image in each viewer via the sensor model. Each viewer supports pan, zoom, and yaw about line of sight. The two viewers are tied together with respect to these operations, i.e., performing an operation in one viewer automatically causes the corresponding operation to be performed in the other.
A two-dimensional Z-profile viewer that may display for any designated three-dimensional vector its profile of XY-arc-length vs. Z, where X, Y, and Z are the coordinates of object space. The viewer supports pan and zoom. The viewer may show, as a dot, the object space coordinates where any other vector crosses or is incident to the current vector.

When the mouse cursor is moved along a vector in any of the viewers, then all other viewers depicting that vector will display the corresponding cursor location.

Each viewer may simultaneously display “before-and-after” vectors for sake of rapid comparison regarding a particular change or operation.

The interface may be allowed to support more than one Z-profile viewer, each viewer showing a different vector. This might be useful when looking at two vectors that cross each other in XY or are incident to each other in XY.

When stereo imagery is available, the algorithm for automatic update of three-dimensional vectors is as follows: (1) Create a high-resolution digital surface model (DSM) in object space from the stereo disparity map; (2) automatically project the existing three-dimensional object space vectors to the two monoscopic rasters using the sensor model; (3) automatically perform two-dimensional vector update on the projected vectors in one of the image rasters; (4) project the updated two-dimensional vectors into corresponding three-dimensional vectors on the DSM using the sensor model; (5) project the three-dimensional vectors on the DSM to the other monoscopic image raster using the sensor model. It is now possible to view the updated three-dimensional vectors in a stereo context.

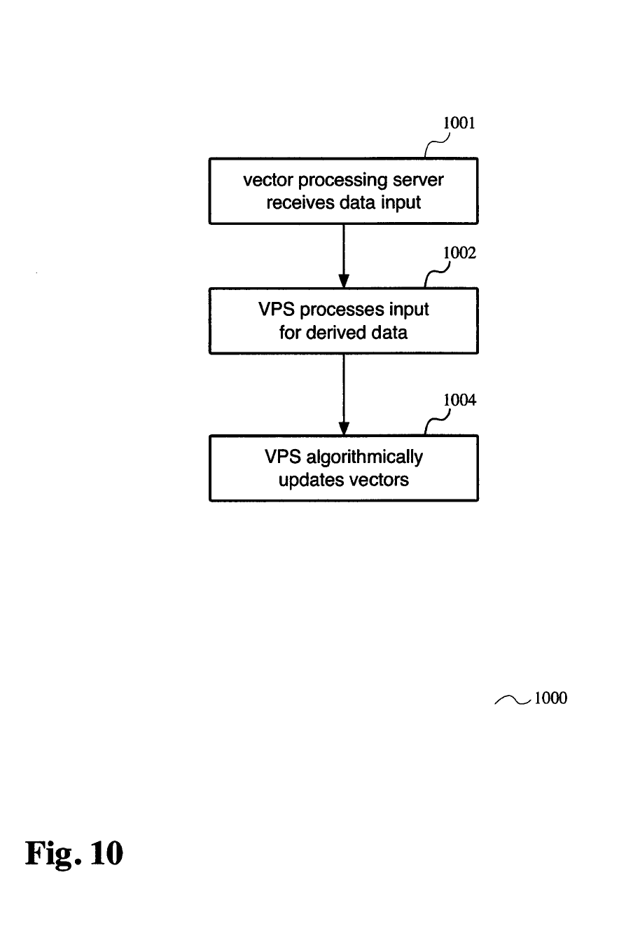

FIG. 10 is a method flow diagram illustrating an exemplary method 1000 for automated vector updating, according to a preferred embodiment of the invention. According to the embodiment, the method 1000 may be used to geometrically update an existing set of three-dimensional linear feature vectors, to make them better coincide with the linear features in an instance of remotely sensed imagery. In an initial step 1001 an input may be received at a vector analysis server, which may then be processed in a next step 1002 to derive vector-based point or path data, or raster-based pixel or cost data (such as described below in greater detail) from the input. In a next step 1004, the derived data may be used to algorithmically process the vectors for updates, such as to conform to a more efficient path based on derived cost data from a raster image, or to “clean up” a vector by removing duplicate or erroneous data.

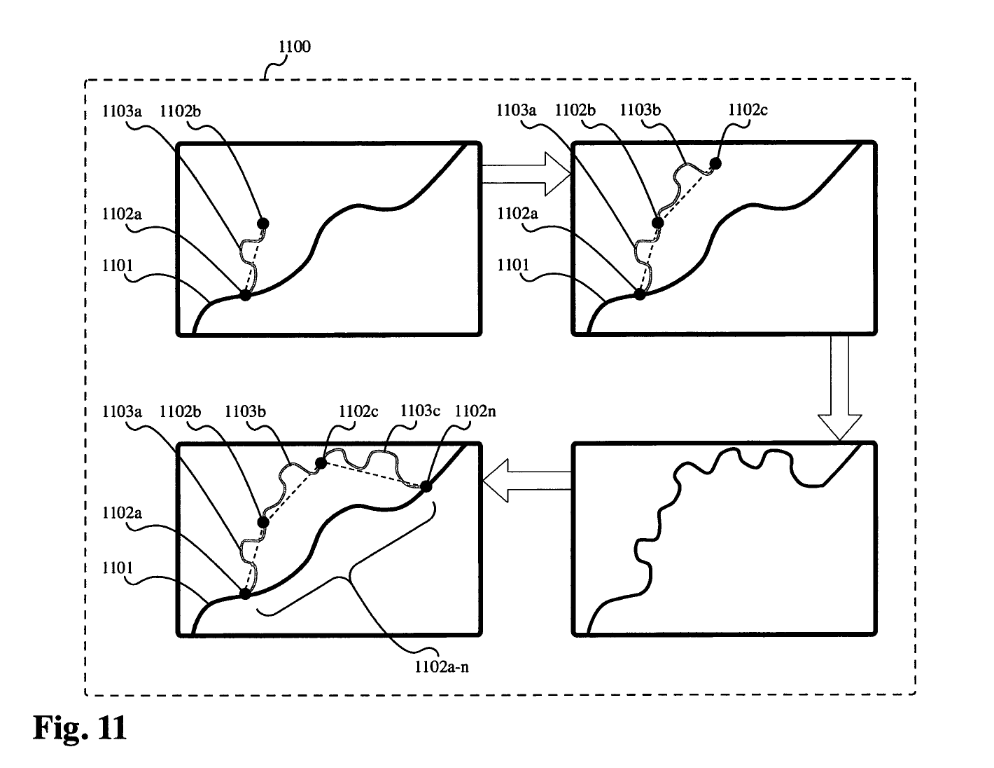

FIG. 11 is an illustration of an exemplary vector display 1100, illustrating the use of automatic vector updating according to the invention. As illustrated, an initial vector 1101 may represent a particular path or similar vector-based feature, such as a road or a river, as might be identified from a raster image. When a new vector point 1102a is selected or plotted (for example, by a human user manually selecting a point with their mouse or other input device, as described above in reference to FIG. 5, or via automated or semi-automated software functions such as by recognizing image features and determining an appropriate location for a new vector point), a vector processing server may apply appropriate automatic processing steps (as described previously, referring to FIG. 10) to identify raster image features and derive a new vector path 1103a accordingly, such as (in an exemplary use case) identifying a most efficient or least-cost path based on recognized terrain or other image features. Such an approach may be useful in a wide variety of situations relying on image input data, such as identifying roads, rivers, geologic or community features such as property lines or forest growth patterns, or any other such arrangement that may benefit from such image-based vector updating as offered by the invention.

The skilled person will be aware of a range of possible modifications of the various embodiments described above. Accordingly, the present invention is defined by the claims and their equivalents.

What is claimed is:

1. A system for advanced vector editing, comprising:
a vector analysis server stored and operating on a network-connected computing device;
a routing calculation server stored and operating on a network-connected computing device; and
a rendering engine stored and operating on a network-connected computing device.
wherein the vector analysis server analyzes a plurality of vector points and provides the results of analysis to the routing calculation server;
wherein the routing calculation server calculates routes based at least in part on the received vector analysis information, and provides the route information to the rendering engine; and
wherein the rendering engine forms visualizations based at least in part on the routing information received.

2. The system of claim 1, further comprising a database, wherein the database stores vector information and provides the stored information to the vector analysis server for use.

3. The system of claim 2, further wherein the database stores raster information.

4. The system of claim 1, further comprising a viewer, wherein the rendering engine provides the visualizations to the viewer.

5. The system of claim 4, wherein the viewer is a visual display screen, wherein the screen displays the visualizations for viewing by a human user.

6. The system of claim 1, further comprising a plurality of user input devices, wherein the user input devices allow a human user to interact with the visualizations.

7. A method for advanced vector editing, comprising the steps of:
positioning, using a rendering engine a cursor on a raster image displayed on a viewer;
calculating, using a routing calculation server, a radius around the cursor;
positioning the radius in contact with a vector path on a raster image; and
recalculating the vector path through the cursor location within the radius.

8. The method of claim 7, further comprising the step of resizing the radius prior to recalculating the vector path.

9. The method of claim 7, further comprising the step of selecting additional points prior to recalculating the vector path.

10. The method of claim 9, wherein the additional points are selected by a human user using a computer input device.

11. The method of claim 9, further comprising the step of recalculating the vector path through each of the selected points.

12. The method of claim 7, further comprising the steps of:
determining, using a routing calculation server, a three-dimensional location from the 2-dimensional raster image;
determining a three-dimensional path;
recalculating the vector path according to the three-dimensional space; and
updating, using a rendering engine, the vector projection on the raster image.

13. The method of claim 12, further comprising the steps of:
calculating, using a routing calculation server, the three-dimensional path according to epipolar geometry;
determining a new three-dimensional location based at least in part on the raster image and the three-dimensional path calculation; and
updating, using a rendering engine, the vector projection via the epipolar geometry.

14. A method for algorithmic vector updates, comprising the steps of:
receiving, at a vector analysis server, a set of input data;
processing the input data to derive updated data values; and
applying at least an algorithm to update the input data based at least in part on the derived data values.

15. The method of claim 14, wherein the input data comprises at least vector-based information.

16. The method of claim 14, wherein the input data comprises at least raster-based image information.

17. The method of claim 16, wherein the derived data values comprise at least a plurality of image features based at least in part on the raster-based image information.

18. The method of claim 17, wherein the algorithm updates the input data based at least in part on the derived image features.
